(19) United States
(12) Patent Application Publication
(10) Pub. No.: US 2009/0146112 A1
(43) Pub. Date: Jun. 11, 2009

(54) COMPOSITE MATERIAL AND METHOD OF PRODUCING THE SAME

(75) Inventor: Kishio YOKOUCHI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/183,777

(22) Filed: Jul. 31, 2008

(30) Foreign Application Priority Data
Dec. 6, 2007 (JP) 2007-315418
Jun. 27, 2008 (JP) 2008-168272

(51) Int. Cl. H01B 1/24

(52) U.S. Cl. 252/510

(57) ABSTRACT

The composite material, which comprises carbon materials and resin, is capable of giving original characteristics of the carbon materials, e.g., carbon fibers, in case of, for example, being used in a circuit board having a core section including carbon fibers. The composite material of the present invention comprises: the carbon materials, which are composed of graphite or materials having graphite structures; and resin. Surfaces of the carbon materials are modified. The resin and the carbon materials are chemically or physically bonded.

### BACKGROUND OF THE INVENTION

The present invention relates to a composite material, which includes carbon materials and resin and which can be applied to, for example, a material of prepregs constituting a core section of a circuit board, and a method of producing the composite material.

In some circuit boards on which semiconductor elements will be mounted, core sections of core substrates include carbon fibers. In the circuit board having the core substrate whose core section includes carbon fibers, a coefficient of thermal expansion is lower than that of a conventional circuit board having a core substrate composed of glass epoxy. Therefore, the coefficient of the circuit board including carbon fibers can be corresponded to that of a semiconductor element, and thermal stress between the semiconductor and the circuit board can be restrained so that a highly reliable circuit board can be produced.

The core section of the core substrate, which includes carbon fibers, is formed by the steps of: laminating a plurality of prepregs, which are formed by impregnating carbon fibers with resin; and heating and pressurizing the laminated prepregs so as to integrate them. The core substrate is formed by laminating cable layers on the both side faces of the core section. The cable layers are formed on the both side faces of the core section by, for example, a buildup method. By forming the cable layers, the circuit board is completed.

The above described conventional technology is disclosed in, for example, Japanese Patent Gazettes No. 2003-273482 and No. 11-269362.

The above described core section including carbon fibers has the low coefficient of thermal expansion, which is lower than that of the glass epoxy substrate, etc., a high coefficient of thermal conductivity and high mechanical strength. The characteristics of the high coefficient of thermal conductivity and the high mechanical strength are effective for core substrates of circuit boards.

Note that, an aramid fiber is an example of an organic material having a low coefficient of thermal expansion and high mechanical strength.

However, aramid fibera have low coefficients of elasticity, so a core section composed of aramid fibers will be influenced by a thermal expansion force of resin. As a result, the characteristic of low coefficient of thermal expansion cannot be obtained. On the other hand, carbon fibers have high coefficients of elasticity, so that the original characteristic of the low coefficient of thermal expansion can be obtained. Further, original characteristics of mechanical strength and thermal conductivity can be obtained.

However, in a resin material, which includes resin and carbon fibers and which is applied to the core section constituted by the prepregs including carbon fibers, bonding strength between carbon fibers and the resin is important for obtaining sufficient original characteristics of carbon fibers.

### SUMMARY OF THE INVENTION

The present invention was conceived to solve the above described problems.

An object of the present invention is to provide a composite material comprising carbon materials and resin, which is capable of giving original characteristics of the carbon materials, e.g., carbon fibers, in case of, for example, being used in a circuit board having a core section including carbon fibers.

Another object is to provide a method of producing the composite material.

To achieve the objects, the present invention has following structures.

Namely, the composite material of the present invention comprises: the carbon materials, which are composed of graphite or materials having graphite structures; and resin, surfaces of the carbon materials are modified, and the resin and the carbon materials are chemically or physically bonded.

Note that, examples of the modifying treatments for improving chemical bonding strength between the carbon material and the resin are: executing a strong alkali treatment to the carbon materials to form active groups in the surfaces thereof; and executing a plasma treatment or an ion beam treatment to the carbon materials to form asperities in the surfaces thereof so as to improve chemical bonding strength between the carbon material and the resin by using anchor function.

For example, carbon atoms in the surfaces of the carbon materials and molecules of the resin may be chemically bonded; and the carbon materials and the resin may be bonded with organic or inorganic materials, which are chemically bonded to carbon atoms in the surfaces of the carbon materials.

Further, the carbon materials may be carbon fibers. With this structure, a coefficient of thermal expansion of the composite material can be lowered and mechanical strength thereof can be increased.

The method of producing the composite material of carbon materials and resin comprises the steps of: performing a modifying treatment so as to form active groups, which are capable of chemically bonding to the resin, or parts, which are capable of physically bonding to the resin, in surfaces of the carbon materials, which are composed of graphite or materials having graphite structures; and bringing the modified carbon materials into contact with the resin so as to from the composite material.

In the method, the strong alkali treatment or the plasma treatment can be used as the modifying treatment.

Further, an electronic device may comprise: carbon materials, which are composed of graphite or materials having graphite structures; and resin, surfaces of the carbon materials may be modified, and the resin and the carbon materials may be chemically or physically bonded.

In the composite material of the present invention, the bonding strength between the carbon materials and the resin can be improved by modifying the carbon materials. Therefore, slip occurred in boundary surfaces between the carbon materials and the resin can be restrained, so that the composite material which sufficiently has original characteristics of the carbon materials can be provided.

### BRIEF DESCRIPTION OF THE DRAWINGS

Embodiments of the present invention will now be described by way of examples and with reference to the accompanying drawings, in which:

FIG. 1 is an electron micrograph showing a sectional structure of a prepreg, which is formed by impregnating carbon fibers with resin;

FIG. 2 is an electron micrograph showing a structure of a yarn;

FIG. 3 is an explanation view showing a state in which the carbon fiber and the resin;

FIG. 4 is an explanation view of a jig for bonding strength tests;

FIG. 5 is a graph showing results of the bonding strength tests; and

FIGS. 6A-6C are sectional views showing the steps of producing a circuit board, which includes a core section composed of a composite material including carbon fibers.

### DETAILED DESCRIPTION OF THE EMBODIMENTS

Preferred embodiments of the present invention will now be described in detail with reference to the accompanying drawings.

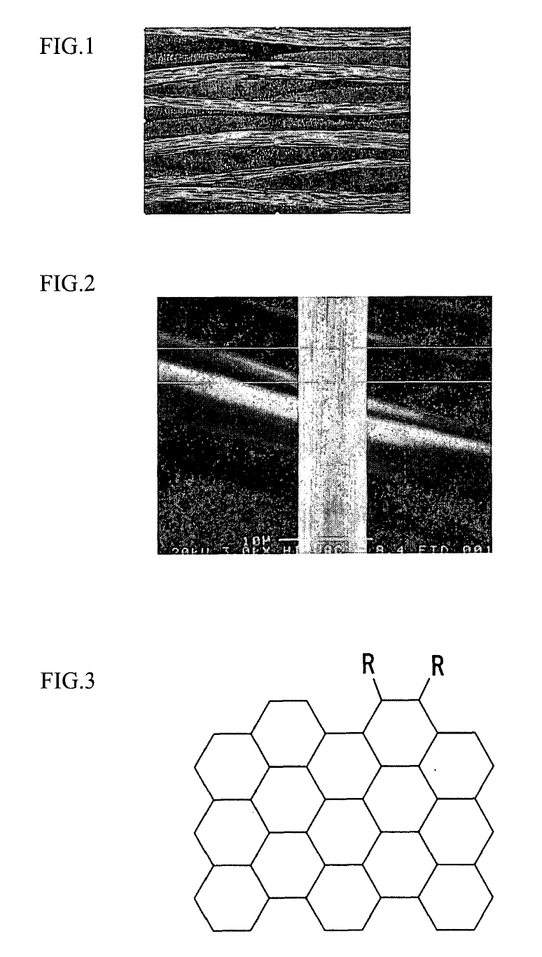

FIG. 1 is an electron micrograph showing a sectional structure of a prepreg, which is formed by impregnating carbon fibers with resin. In FIG. 1, parts extended in the horizontal direction show longitudinal sections of the carbon fibers; parts in which small dots are concentrated are transverse sections of the carbon fibers; and black parts between the carbon fibers are resin parts.

The carbon fibers shown in FIG. 1 are bundled to form into bunches of the carbon fibers. Generally, in case of forming a woven cloth with carbon fibers, bunches of carbon fibers are used.

The prepreg shown in FIG. 1 is formed by weaving a cloth with carbon fibers and impregnating the carbon fibers with resin. Therefore, spaces between the carbon fibers are filled with the resin.

FIG. 2 is an enlarged electron micrograph of one yarn (one bunch of carbon fibers). In a carbon fiber formed by graphitizing a resin fiber at high temperature, e.g., 3000° C., shallow grooves are formed in an outer face of the carbon fiber, but the outer face is very smooth. Therefore, in case of forming a prepreg by impregnating the woven cloth composed of the carbon fibers with resin, the carbon fibers and the resin are apparently bonded, but mechanical bonding strength therebetween is weak or they are not substantially bonded. Further, the graphitized carbon fibers are chemically stabilized and are not chemically bonded to the resin.

Therefore, in a core section produced by laminating a plurality of prepregs, each of which is formed by impregnating carbon fibers with resin, and heating and pressurizing the laminated prepregs, slip occurs between the carbon fibers and the resin, so original superior characteristics of the carbon fibers, e.g., low coefficient of thermal expansion, high mechanical strength, cannot be obtained.

In the composite material, which comprises carbon materials and resin, and the production method of the present invention, the carbon materials are modified so as to improve chemical or physical bonding strength between the carbon materials and the resin, so that characteristics of the carbon materials are reflected as characteristics of the composite material.

For example, in case of using graphitized carbon fibers as the carbon materials, the carbon fibers are modified so as to easily chemically bond the carbon fibers to the resin or improve physical (mechanical) bonding strength between the carbon fibers and the resin.

FIG. 3 shows the state in which the graphitized carbon fibers are chemically bonded to the resin R. By chemically bonding the graphitized carbon fibers to the resin, the slip occurred in boundary surfaces between the carbon fibers and the resin can be restrained, so that the original characteristics of the carbon fibers, e.g., low coefficient of thermal expansion, high mechanical strength, can be obtained as characteristics of the composite material comprising the carbon fibers and the resin.

In case of using the composite material as a core member of a circuit board, a coefficient of thermal expansion of the circuit board can be lowered. Therefore, the coefficient of thermal expansion of the circuit board can be corresponded to that of a semiconductor element to be mounted on the circuit board. By increasing the mechanical strength of the circuit board, deformation of the circuit board can be prevented, so that reliabilities of the circuit board, a semiconductor package, a semiconductor device, etc. can be improved.

Next, concrete examples of applying the modifying treatment to graphitized carbon fibers will be explained.

### (Strong Alkali Treatment)

A strong alkali treatment is performed by applying strong alkali to graphitized carbon fibers so as to form hydroxyl groups in surfaces of the carbon fibers as active groups.

For example, an inorganic alkali electrolytic solution, which is an aqueous solution of 1-3 mol/m³ of sodium hydroxide, potassium hydroxide, ammonium bicarbonate or ammonium hydrogencarbonate, is used. The carbon fibers or bunches of the carbon fibers are soaked into the electrolytic solution as an anode. Voltage, e.g., 2 V, is inputted to the anode for 10 minutes, so that hydroxyl groups can be partially formed in the surfaces of the graphitized carbon fibers.

In another example, an electrolytic solution, which is an aqueous solution of 1-3 mol/m³ of sulfuric acid or nitric acid, is used. The carbon fibers or bunches of the carbon fibers are soaked into the electrolytic solution as an anode. Voltage, e.g., 2 V, is inputted to the anode for 10 minutes, so that hydroxyl groups can be partially formed in the surfaces of the graphitized carbon fibers.

By bringing the carbon fibers, in which the hydroxyl groups have been formed in the surfaces, into contact with the resin, the resin and the hydroxyl groups chemically bond to each other, so that adhesiveness and bonding strength between the carbon fiber and the resin can be improved.

### (Plasma Treatment)

A plasma treatment may be performed by, for example, setting graphitized carbon fibers or bunches of the graphitized carbon fibers in a chamber and plasma-discharging under reduced pressure. Alcohols or aldehydes may be introduced into the chamber. Further, an inner space of the chamber may be a carbonic anhydride atmosphere. The plasma discharge is performed at a temperature range between the room temperature and about 200° C.

By the plasma treatment, active groups, e.g., ketone groups, ether group, hydroxyl groups, can be partially formed in the surfaces of the carbon fibers.

By applying the plasma treatment to the carbon fibers, the carbon fibers and the resin can be chemically bonded, and adhesiveness and bonding strength between the carbon fiber and the resin can be improved.

### (Ion Beam Treatment)

Atoms of nitrogen, oxygen, etc. are radiated toward graphitized carbon fibers or bunches of graphitized carbon fibers, by an ion accelerator (200 keV, 10 μA), with a fluence rate of 1014-1018/cm², under reduced pressure at room temperature so as to modify surfaces of the carbon fibers.

After radiating ions, ether groups C—O—C, carbonyl groups C═O, carbon bonded to oxygen radical C—O., amino groups, etc. are partially formed in the surfaces of the carbon fibers, which originally have graphite structures composed of carbon atoms only. By exposing in the air, the carbon bonded to oxygen radical C—O. becomes a hydroxyl group C—OH, reacts to precursors of a resin and is chemically bonded thereto as well as the carbonyl groups. Therefore, the structure highly reacting to the resin can be formed. In case of producing a printed circuit board, the modified carbon fibers are impregnated with resin and chemically bonded to the precursors of the resin while performing a laminating and a heating steps, so that high bonding strength can be obtained.

(Intercalation with Strong Alkali)

Lithium ions or potassium ions are made penetrate into a space between graphite layers under high pressure, e.g., 10 atmospheres, at high temperature, e.g., 300° C., and then the graphite layers are heated at normal pressure so as to partially occur layer separation. Therefore, physical bonding strength between the graphite layers and resin can be improved. Further, in a cleaning process performed after impregnating the graphite layers with resin, hydroxyl groups C—OH are partially formed. Therefore, in case of producing a printed circuit board, the modified carbon fibers are impregnated with resin and chemically bonded to the precursors of the resin while performing a laminating and a heating steps, so that high bonding strength can be obtained.

### (Bonding Strength Test)

Carbon fibers were respectively treated by the strong alkali treatment method, the plasma treatment method, the ion beam treatment method and the intercalation treatment (mixed acid treatment) method, and woven cloths (carbon fiber woven cloths) were woven with the modified carbon fibers. The carbon fiber woven cloths were impregnated with precursors of resin so as to form carbon fiber prepregs. Each of samples was produced by laminating the carbon fiber prepregs under prescribed press conditions, e.g., 1 Mpa, 200° C., 120 minutes. Each of the samples was formed into a plate having a thickness of 1 mm.

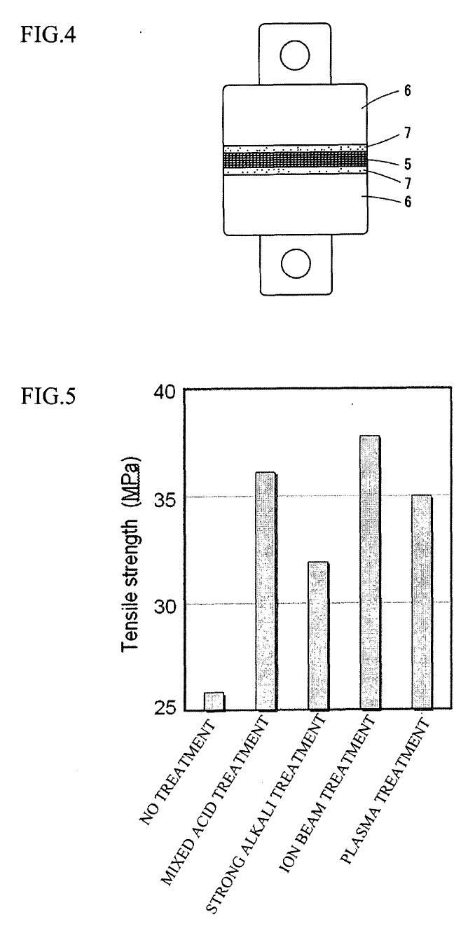

As shown in FIG. 4, a bonding strength test was performed by the steps of: clamping the sample 5 with an aluminum jig 6, whose diameter was 10 mm, so as to bond the sample 5 thereto; and measuring peeling strength. Note that, the sample 5 was bonded to the jig 6 by an adhesive 7.

Results of the bonding strength tests (tensile tests) are shown in a graph of FIG. 5. In the graph, “NO TREATMENT” indicates the result of the sample in which the carbon fibers were impregnated with the precursors of the resin material without performing the modifying treatment, e.g., strong alkali treatment, plasma treatment. According to the graph, bonding strengths of other treated samples, in each of which the carbon fibers were modified, were highly greater than that of the untreated sample, whose carbon fibers were not modified.

Fracture cross sections of the samples were observed. In the untreated sample, the fracture occurred in a boundary surface between the carbon fibers and the resin. On the other hand, in the treated samples, the fractures occurred in the resin parts. Therefore, the carbon fibers and the resin were chemically bonded by the modifying treatment, so that the bonding strength therebetween was improved, we think.

According to the results, a substrate composed of the treated carbon fibers can be applied to a circuit board having sufficient mechanical strength.

### (Example of Using the Composite Material)

An example of using the carbon-resin composite material of the present invention will be explained.

Firstly, prepregs are formed by weaving cloths with the carbon fibers, whose bonding property to the resin has been improved by the modifying treatment, or by the steps of: arranging carbon fibers parallel; impregnating the carbon fibers with resin; and drying the carbon fibers until it forms a half-dried B-stage. A plurality of the prepregs are laminated, and the laminated prepregs are heated and pressurized to form into a plate-shaped member. The plate-shaped member can be used as a core section of a circuit board. Note that, number of laminating the prepregs may be defined on the basis of a coefficient of thermal expansion, mechanical strength, etc.

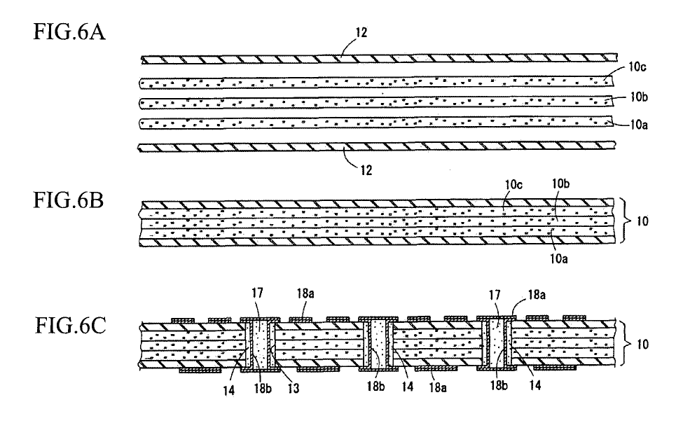

FIGS. 6A-6C shows the steps of producing a circuit board includes a core section constituted by three prepregs 10a, 10b and 10c, which are carbon fiber woven cloths impregnated with resin.

In FIG. 6A, the prepregs 10a, 10b and 10c and prepregs 12 including fillers, which will cover the both side faces of the core section, are correctly set as shown. In this state, the prepregs 10a, 10b, 10c and 12 are heated and pressurized so as to produce the core section 10 including the carbon fibers. The completed core section 10 is shown in FIG. 6B). Since the carbon fibers are previously modified so as to improve bonding property to the resin material before forming the prepregs 10a, 10b and 10c, the core section 10 can have original characteristics of the carbon fibers, e.g., low coefficient of thermal expansion, high mechanical strength.

In FIG. 6C, pilot holes 13 for forming plated through-holes are bored in the core section 10. The pilot holes 13 are filled with electrically-insulating resin 14. Next, through-holes are formed in the resin 14, and electrically-conductive layers are formed on inner feces of the thorough-holes. The through-holes are filled with resin 17. Electrically-conductive layers are formed on the both side faces of the core section 10, and then the conductive layers are patterned to form cable patterns 18a. By forming the cable patterns 18a, a core substrate is completed. The conductive layers formed on the inner faces of the through-holes are the plated through-holes 18b.

Cable layers are formed on the both side faces of the core substrate by, for example, a build-up method. By forming the cable layers, the circuit board is completed.

Since the core section 10 of the circuit board includes the carbon fibers, the bonding strength between the carbon fibers and the resin material is improved. Therefore, the core section 10 sufficiently has the original characteristics of the carbon fibers, e.g., low coefficient of thermal expansion, high mechanical strength, so that reliability of a semiconductor device, in which a semiconductor element is mounted on the circuit board, can be improved. Since the core section has high mechanical strength, a thin circuit board having enough mechanical strength can be produced. Further, since the core section has good thermal conductivity, a semiconductor device capable of well radiating heat can be produced.

Note that, the carbon-resin composite material of the present invention can be applied to not only core sections of multilayered circuit boards but also ordinary printed circuit boars, many types of semiconductor packages, encapsulating members of packages, substrates for evaluating semiconductor wafers, radiator plates of electronic parts, etc.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A composite material,
comprising:
the carbon materials, which are composed of graphite or materials having graphite structures; and
resin,
wherein surfaces of the carbon materials are modified, and
the resin and the carbon materials are chemically or physically bonded.

2. The composite material according to claim 1,
wherein carbon atoms in the surfaces of the carbon materials and molecules of the resin are chemically bonded.

3. The composite material according to claim 1,
wherein the carbon materials and the resin are bonded with organic or inorganic materials, which are chemically bonded to carbon atoms in the surfaces of the carbon materials.

4. The composite material according to claim 1,
wherein the carbon materials are carbon fibers.

5. A method of producing a composite material of carbon materials and resin,
comprising the steps of:
performing a modifying treatment so as to form active groups, which are capable of chemically bonding to the resin, or parts, which are capable of physically bonding to the resin, in surfaces of the carbon materials, which are composed of graphite or materials having graphite structures; and
bringing the modified carbon materials into contact with the resin so as to from the composite material.

6. The method according to claim 5,
wherein the modifying treatment is a strong alkali treatment.

7. The method according to claim 5,
wherein the modifying treatment is a plasma treatment.

8. The method according to claim 5,
wherein the carbon materials are carbon fibers.

9. An electronic device,
comprising:
carbon materials, which are composed of graphite or materials having graphite structures; and
resin,
wherein surfaces of the carbon materials are modified, and
the resin and the carbon materials are chemically or physically bonded.
